(19) United States
(12) Patent Application Publication
(10) Pub. No.: US 2010/0088991 A1
(43) Pub. Date: Apr. 15, 2010

(54) Method of Producing a Vacuum Panel, One Such Vacuum Panel, and a Masonry Block Using the Panel

(75) Inventors: Manfred Woschko, Loewenstein (DE); Donat Woschko, Obersulm (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Woschko Winlite GmbH, Weinsberg (DE)

(21) Appl. No.: 12/518,614

(22) PCT Filed: Dec. 10, 2007
(86) PCT No.: PCT/EP07/10758

§ 371 Date: Jun. 10, 2009

(30) Foreign Application Priority Data
Dec. 13, 2006 (DE) 10 2006 058 804.5
Mar. 21, 2007 (DE) 10 2007 013 584.1

(51) Int. Cl. E04B 1/80; B29C 45/14; B32B 1/06; B32B 15/00; B23K 31/02; E04C 2/04

(52) U.S. Cl. 52/407.5; 264/102; 428/69; 428/63; 228/101; 52/596

(57) ABSTRACT

A method of producing a substantially parallelepiped vacuum panel which has, in an outwardly gas-tight manner in a sleeve or envelope, a filling made of granular or powdered degassed support elements, preferably silica particles, the interior of the sleeve being evacuated and the support elements being moved closely together and being enclosed by the sleeve, the sleeve comprising an encapsulation by injection-molding or overmolding of a plastic material. For forming two sides of the sleeve remote from one another, metal plates are provided, between which the support elements are arranged. The peripheral rims of the metal plates are positively and non-positively embedded by the encapsulation by injection-molding and/or overmolding. Additionally, a permeation barrier layer may be provided on at least the encapsulation by injection-molding and/or overmolding. Moreover, getter materials may be provided between the support elements.

The invention relates to a method of producing a substantially parallelepiped vacuum panel, a vacuum panel produced according to the method and the use of such a vacuum panel in a thermally insulating multi-shell masonry block.

Thermal insulation based on evacuated insulating panels, so-called vacuum panels, are increasingly considered as an alternative type of thermal insulation, in particular for buildings.

Essential to such vacuum panels is the vacuum-tight seal, relative to the outside, of a filling made of granular or powdered degassed support elements, in particular silica particles, the interior being evacuated and the support elements being moved closely together. Typically, such a vacuum panel consists of a single-walled or multi-walled gas-tight sleeve or envelope and a filling of such support elements, the interior of the sleeve being evacuated, the support elements being moved closely together and being enclosed by the sleeve in a close-fitting manner. Such vacuum panels are already known in many different forms, for example from EP 0 106 103 A1, U.S. Pat. No. 4,668,551 and WO 00/71849 A1.

It has already been recognized at an early stage that, in practice, the principal structural design of such vacuum panels also has to be such that in severe conditions, in particular on building sites, they exhibit sufficient resistance, even against accidental damage. According to the prior art, it is known to provide a gas-tight sleeve consisting substantially of plastic, with additional coverings, such as a metal foil, in particular aluminum foil (EP 1 557 504 A1). In particular, for an application as a thermally insulating element in a multi-shell masonry block it is, moreover, known (EP 1 557 249 A1) to define the narrow sides of the cuboid by walls of a plastic tube with a rectangular cross section and to seal the end openings in a gas-tight manner by a cover, or even after evacuation to encapsulate the arrangement comprising the plastic sleeve and filling by overmolding and/or injection-molding with a plastic material. Although the known methods must be viewed in any case as a step in the right direction, they are not yet able to overcome the aforementioned problems completely, in particular also considering the fact that the vacuum panels have to maintain the thermal insulation effect over a lengthy time period. When used in buildings, therefore, a time period of approximately 30 years or more has to be considered.

It is, therefore, the object of the present invention to provide the possibility of creating vacuum panels which may be produced in the factory at a reasonable economic cost, and which maintain this characteristic over lengthy time periods even in severe conditions.

The object is achieved in a method of producing a vacuum panel by the features of claim 1 or claim 14. The object is achieved by a vacuum panel with the features of claim 23 or claim 35. A particular application is characterized in claim 43.

The invention is developed by the features of the dependent claims.

Important for the present invention is the recognition that the surfaces of the vacuum panel that in practical use come into contact with the mutually thermally insulating surfaces are protected by a metal plate, whilst the other surfaces, which are frequently exposed, consist of material of lower thermal conductivity and may be equipped for increasing the service life, in order to prevent permeability losses (reduction of the vacuum in the interior of the vacuum panel).

The invention is described in more detail with reference to the exemplary embodiment shown in the drawings, in which:

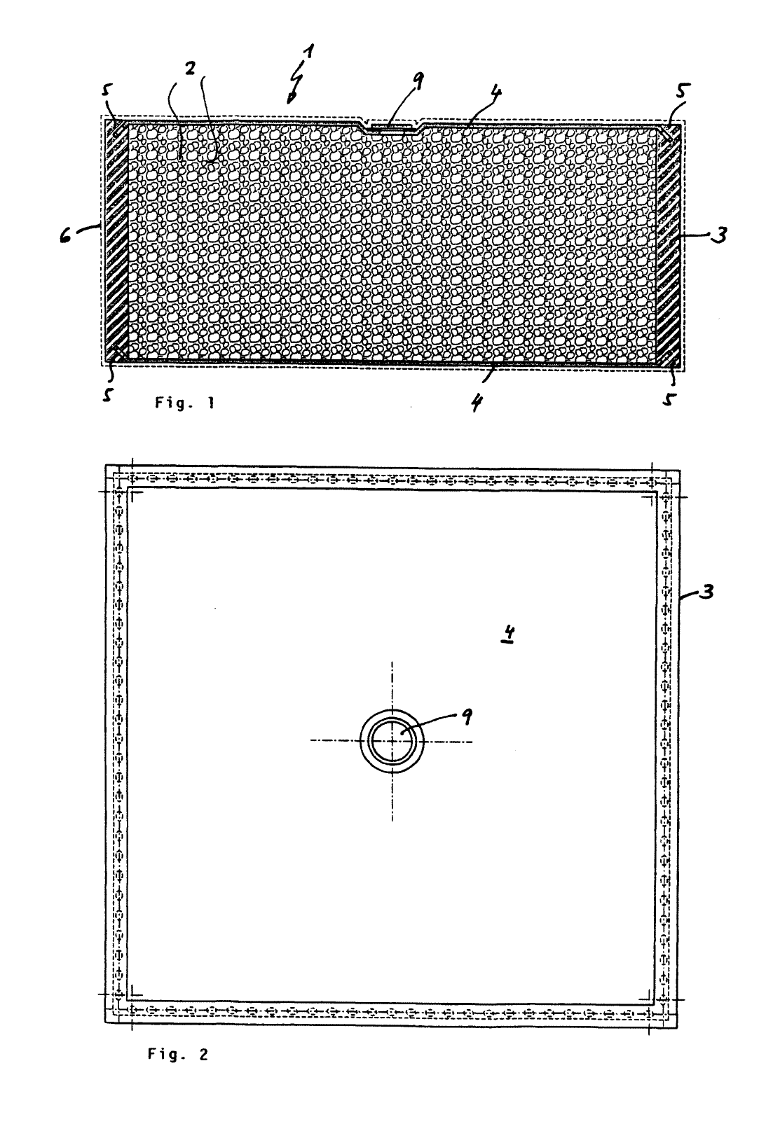

FIG. 1 shows a first exemplary embodiment of the invention,

FIG. 2 shows in plan view the exemplary embodiment according to FIG. 1,

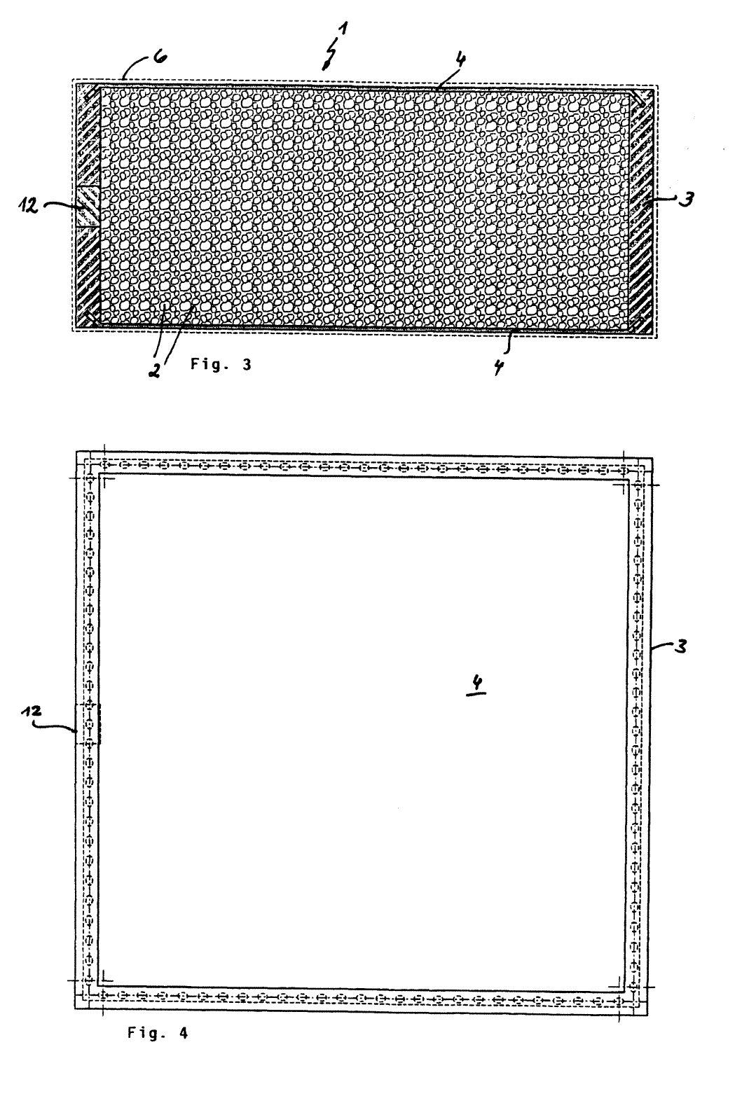

FIG. 3 shows a second exemplary embodiment of the invention,

FIG. 4 shows in plan view the exemplary embodiment according to FIG. 3,

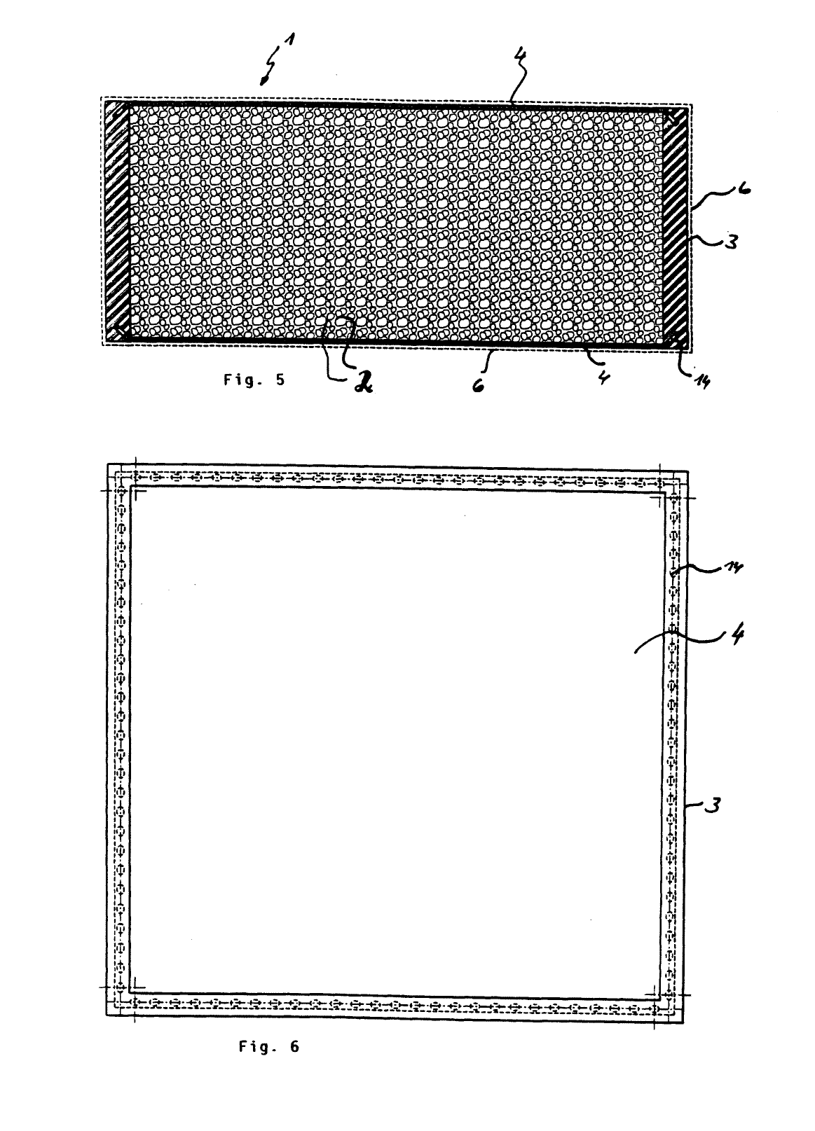

FIG. 5 shows in section a further exemplary embodiment of the invention,

FIG. 6 shows in plan view the exemplary embodiment according to FIG. 5,

FIG. 7 shows a detail of the exemplary embodiment according to FIG. 1,

FIG. 8 shows in plan view the detail according to FIG. 7,

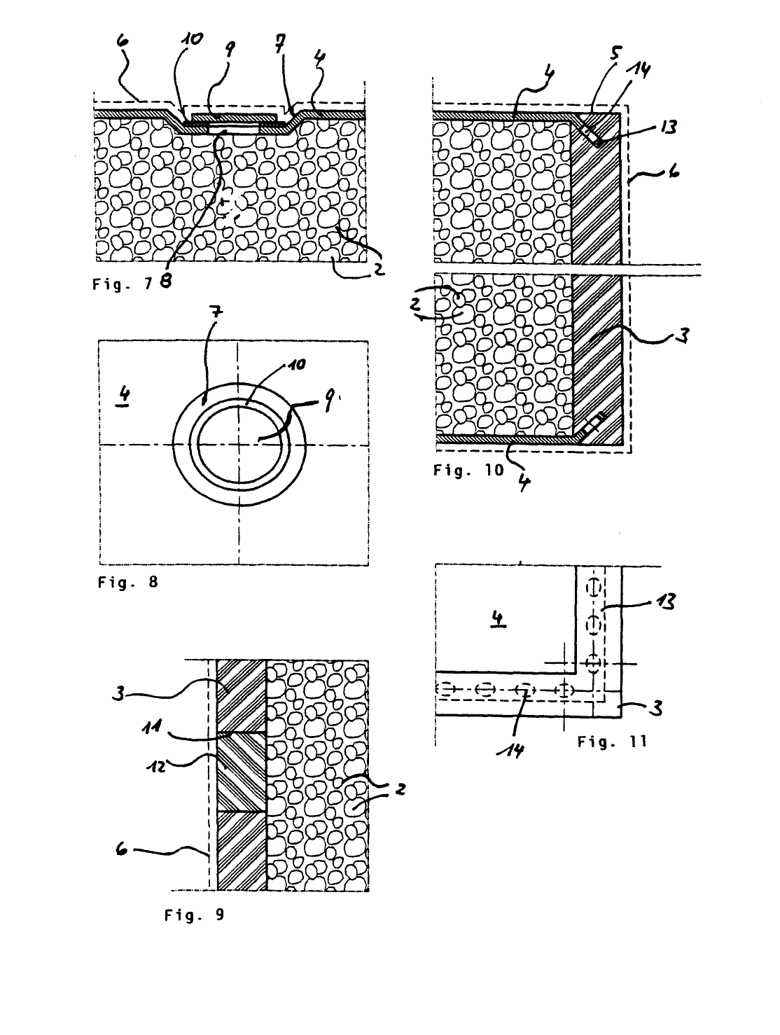

FIG. 9 shows a detail of the exemplary embodiment according to FIG. 3,

FIG. 10 shows in section details of the exemplary embodiments 1 to 3,

FIG. 11 shows in plan view the detail according to FIG. 10,

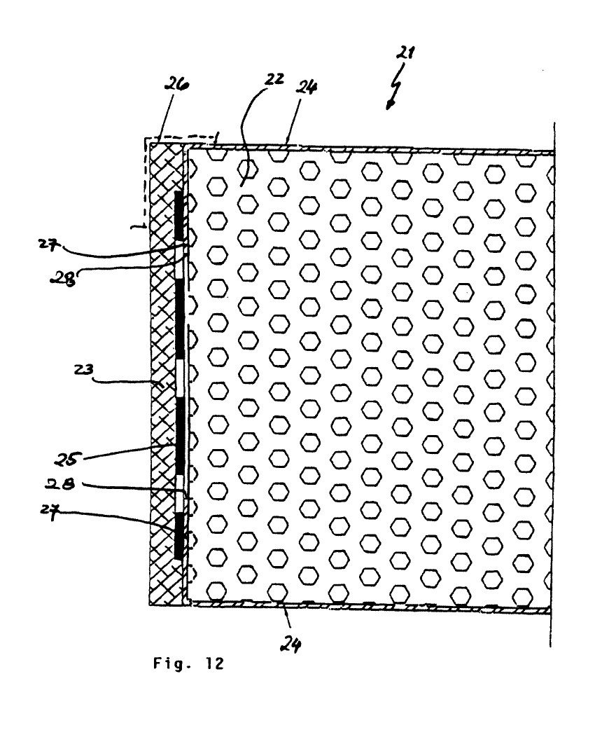

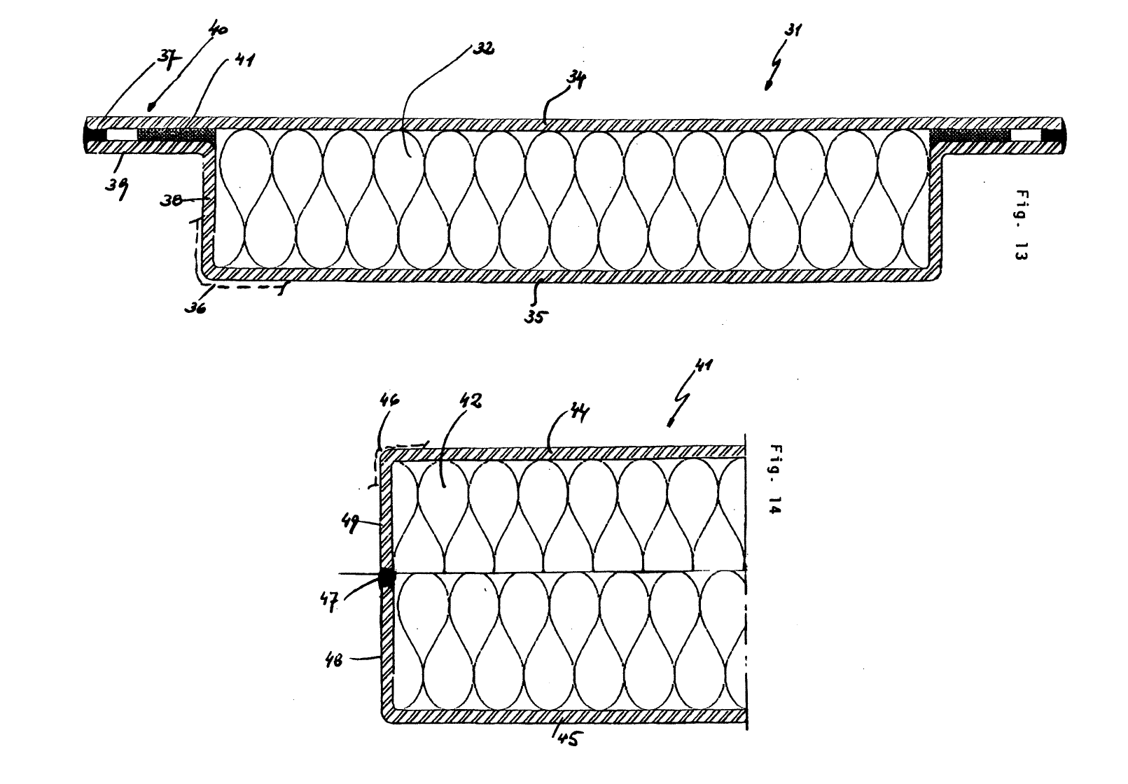

FIG. 12 shows a fourth exemplary embodiment of the invention,

FIG. 13 shows a fifth exemplary embodiment of the invention,

FIG. 14 shows a sixth exemplary embodiment of the invention,

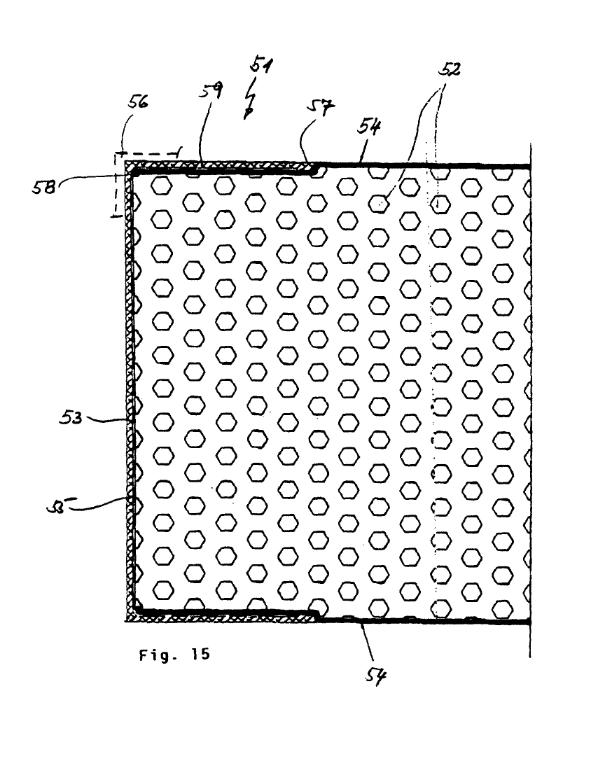

FIG. 15 shows a seventh exemplary embodiment of the invention.

The invention is described hereinafter initially with reference to exemplary embodiments in which the vacuum panel substantially corresponds to a cuboid with a square base, its thickness being markedly less. By the term “thickness direction” is in this case to be understood the direction in which two thermally insulating elements, not shown, are spaced apart from one another and between which the vacuum panel may be arranged during use.

Initially, the common features of all exemplary embodiments are explained below.

A vacuum panel 1 has a sleeve or envelope which may be evacuated and/or is evacuated, described in further detail below, with a filling 2 made of support elements, namely made of granular or powdered degassed support elements such as, in particular, silica particles. The sleeve consists of a peripheral plastic edging 3 extending in the thickness direction, which is sealed at the end by metal plates 4. The metal plates 4 are fixedly attached in a vacuum-tight manner to the outer ends 5 of the plastic edging 3 in the thickness direction. The material of the filling 2 is inserted into the sleeve defined by the plastic edging 3 and the metal plates in a close-fitting manner. The interior of the sleeve is, moreover, evacuated. Furthermore, in the exemplary embodiment shown by dashed lines, the sleeve has a relatively thin barrier layer 6 entirely enclosing the sleeve. As explained in further detail below, this barrier layer 6 on the metal plates 4 may be omitted, as the barrier layer serves as a permeation barrier layer and the metal plates 4 are possibly already sufficiently sealed against permeation as a result of their material.

According to the invention, various possibilities may be conceived for evacuating the interior of the sleeve.

The method according to FIGS. 1 and 2 in the first exemplary embodiment is explained in further detail, in particular, with reference to FIGS. 7 and 8. In at least one of the metal plates 4, advantageously in a depression 7, an opening 8 is provided through which the evacuation is carried out. After the evacuation has taken place, the opening 8 is sealed by means of a cover 9, which is bonded in position, for example, via an adhesive ring 10 in a vacuum-tight manner.

A further possibility, indicated in FIG. 3 and FIG. 4, is explained in further detail with reference to FIG. 9. Here the plastic edging 3 has at at least one point an opening 11, through which the evacuation takes place. After the evacuation is complete, the opening is then sealed relative to the outside in a vacuum-tight manner by means of a plug 12 which is expediently bonded in position.

The fixed connection between the metal plates 4 and plastic edging 3 is, in particular, explained in further detail with reference to FIGS. 10 and 11. The metal plate 4 has a peripheral flanged portion 13, preferably of the order of magnitude of 45° relative to the plane of the metal plate 4, openings 14 or perforations also being provided peripherally in the region of the flanged portion 13. The plastic edging 3 is achieved by encapsulation by overmolding or injection-molding, preferably by means of a polyurethane or epoxy resin, the fixed and sealed connection being substantially achieved by the plastic material passing through the openings 14 during the encapsulation by injection-molding and/or overmolding.

It has been shown that it is also possible to arrange the support elements 2 of the filling between the two metal plates 4, to evacuate this arrangement and then to provide the plastic edging 3 by encapsulation by injection-molding or overmolding, the encapsulation by injection-molding or overmolding thus having to take place under vacuum conditions. In such cases, openings such as the opening 8 or the opening 11 are no longer necessary for the purposes of the evacuation.

The manner of the evacuation is dictated by the conditions of manufacture.

As has been mentioned above, the barrier layer 6 is not necessarily required with the metal plates 4 but with the plastic edging 3 it is frequently necessary.

This requirement will now be explained, as follows: in thermal insulation, in particular so-called alternative thermal insulation for buildings, based on evacuated thermal insulation panels, so-called vacuum panels, it is extremely important to maintain the vacuum. In applications for buildings, the vacuum should be maintained at the required level for at least 30 years.

A parallelepiped vacuum panel might be considered with the basic construction set forth above, with the dimensions: 480×240×30 mm, the filling consisting of so-called microporous silica particles. This panel has to withstand atmospheric pressure of approximately 10 t. The metal plates 4 are in this case formed by aluminum sheets 0.5 mm thick, the plastic edging 3 consisting of polyurethane approximately 30 mm thick.

When considering this example, powdered material is used. The thermal losses through the panel are substantially determined by three factors, namely the thermal conductivity of the filling material, the thermal conductivity of possible residual gases and the thermal radiation. The thermal conductivity of the residual gas, of the gas remaining after evacuation and/or of the gas permeating over time through the walls, in particular air once more, will be considered. The thermal conductivity depends very much on the factor of the mean free path length of the molecules. In other words, the path of the molecules between two collisions and the particle size. At a pressure of 1 hPa=1 mbar, the mean free path length of air is approximately 40 μm. With particles of this order of magnitude, the thermal conductivity is inversely proportional to the pressure. In other words, the lower the pressure, the lower the heat losses and thus also the component of the total thermal balance. It may firstly be concluded therefrom that it is not necessary to produce a greater vacuum, if the component is already 0. Secondly, as the powder of the powdered material becomes finer, the pressure which is still permissible becomes greater. The choice of powder in this case has to be considered from an economic point of view, as finer powders are typically more expensive than, for example, standard available powder. The proposed material (silica particles) has a thermal conductivity of 10 mW/mK. At a pressure of approximately 1 to 5 hPa, this value is lower and lies often in the region of approximately 0.4 mW/mK.

In the panel under consideration, together with the filling under consideration, the volume of the enclosed air with a pore component of 75% is:

V_{L}=48 cm×24 cm×3 cm×0.75=2592 cm³, i.e. approximately 2.6 l.

The surface area of the metal plates 4 is:

F_{F}=(48 cm×24 cm)×2=0.23 m².

The area of the plastic edging 3 is:

F_{K}=(2×48 cm+2×24 cm)×3 cm=0.043 m².

Initially the permissible leakage rate has to be determined, namely based on a passive characteristic of the filling. This total leakage rate is made up of the actual leakage due, for example, to holes in the sleeve, to virtual leaks, such as air bubbles remaining after evacuation, and to possible permeation through the walls of the vacuum panel, namely the metal plates 4 and the plastic edging 3. When considering a service life of 30 years and a permissible pressure increase during these 30 years of 5 hPa, a permissible mean leakage rate of 5 hPa×2.6 l/3600×24×365×30 s=1.4×10⁻⁸ hPa l/s results. Such a leakage rate is still measurable at any rate for industrial installations, for example by means of helium leak detectors or the like.

The diffusion and/or permeation is now considered and, in particular, initially the diffusion through metal walls, such as the metal plates 4. In metals and at normal temperatures, the permeation typically relates only to the hydrogen component. In air this is approximately 1×10⁻⁴ hPa, which in the case under consideration may be regarded as insignificant. When considering high-grade steel as a material for the metal plate 4, taking into account that the walls may also be partially wet or may be covered by a water film, for the permeation flow l_{FS}=2279 F/d×e^{-6710/T}×pH, with the surface area F in m², the thickness d in mm, the temperature in K and the pH value of the water film. For a mean ambient temperature of 10° C. and a pH value of 5 (corresponding to a numerical value of 10⁻⁵) the permeation flow for the panels under consideration, through the metal plates 4, is approximately 5×e⁻¹³ hPa l/s, a value which is insignificant. Reference might be made to the fact that even for a vapor-deposited and pinhole-free layer of only 50 nm this permeation flow would be 5×10⁻⁹ hPa l/s, which would still also be insignificant.

However, consideration has to be given to the fact that with other materials, namely conventional industrial aluminum, considerably less favorable conditions may exist.

The permeation flow through the plastic edging 3 is markedly greater. In this case, details are provided of known values for epoxy resin, assuming that for polyurethane the values do not deviate substantially. In this case, a permeation flow of l_{Sk}=0.5 F/d (hPa l/s) results. With a surface area of F=0.043 m² and a thickness of d=30 mm at 60% air humidity the value l_{Sk} is the value of 7×10⁻⁴ hPa l/s, i.e. a value which is 4 orders of magnitude greater than the aforementioned permissible value.

For this reason, and in any case with uses of the vacuum panels over lengthy periods of time, the aforementioned barrier layer 6 is required as a permeation barrier for thermal insulation purposes.

Initially a covering with an aluminum foil at least 20 μm thick will be considered, with the condition that it is applied sufficiently thickly and it is not subjected to any damage. The thermal transfer through side walls equipped in this manner is thus W_{S}=λdL/h ΔT. With d=2×10⁻⁵ m, λ=200 W/mK, L=1.52 m and h=0.03 m, a value of W_{S}=202 mW/K results. This value is in any case far too high in the application under consideration, which is why for the aforementioned application such an aluminum foil is in any case not considered as a permeation barrier. A permeation barrier as a result of a vapor-deposited or sputtered layer, in particular a 50 nm thick aluminum barrier layer, produces a thermal conductivity of 5×10⁻⁹/2×10⁻⁵×202=0.05 mW, which represents an insignificant value, which is why such a layer could form an adequate barrier layer. However, pinhole-free layers cannot be produced under the industrial conditions discussed. The term “industrial conditions” means in this case that clean room conditions are not present, such as in semiconductor manufacture. Thus such a barrier layer would not be pore-free and, for just one pore with a 10 μm diameter, the thermal conductivity is already 9×10⁻⁸ hPa l/s. In other words, a value which is eight times greater than the permissible value. Even with smaller pore diameters it has to be considered that several hundred such pores have to be taken into account for each panel, so that in the application under consideration, such a barrier layer would also not be adequate. It is also possible to apply quartz-like layers based on HMDS. Such layers are typically used in polyethylene bottles or PET bottles, and achieve a barrier effect which is a maximum of 100 times greater. This is, however, still inadequate for the application under discussion here.

It is, therefore, extremely expedient and possibly also imperative for the selected application to introduce getter materials into the sleeve in addition to the support elements, namely getter materials for removing oxygen, as oxygen exhibits the greatest permeation rate. A getter material should be used which is able to absorb relative to oxygen up to 130 hPa l per gram, thus over a 30-year operating time, an overall absorption capacity is achieved which is substantially identical to the permeation due to pinholes of an aluminum covering on the plastic edging 3.

The getter material, which is typically obtained in pellet form, may also be provided in greater quantities.

The getter material has to be activated, which is moreover achieved expediently by thermal treatment for a specific time duration after completing the vacuum panel. Optionally, localized heating through the wall of the vacuum panel may suffice.

It has been shown that by suitable post-treatment, in particular applying a barrier layer and providing getter materials, the vacuum panel according to the invention may be equipped even for a very long service life, so that overall a vacuum panel may be provided which may be economically produced and which is also sufficiently robust on building sites.

Further exemplary embodiments of the invention are explained in more detail below.

According to FIG. 12, a vacuum panel 21 has a sleeve which may be evacuated and/or is evacuated, which is described in further detail below, with a filling 22 made of support elements, namely of granular or powdered degassed support elements, such as in particular silica particles. The sleeve consists of a peripheral plastic edging 23 extending in the thickness direction, which is sealed at the ends by metal plates 24. The metal plates 24 have rims 27 oriented towards one another and substantially bent back at right angles, their edges 28 being spaced apart from one another. These peripheral rims 27 of the metal plates 24 are fixedly connected to one another by a peripheral adhesive strip 25, and this arrangement is entirely enclosed peripherally by the plastic edging 23 so that the interior, i.e. the region between the metal plates 24 and the adhesive strip 25, is sealed in a gas-tight manner. The material of the filling 22 is introduced into the sleeve thus defined in a close-fitting manner. The interior of the sleeve is, in addition, evacuated. Moreover, in the exemplary embodiment shown, the sleeve has a relatively thin barrier layer 26 entirely enclosing the sleeve, shown schematically and only partially by dotted lines. As explained in further detail above, this barrier layer 26 on the metal plates 24 may be omitted, as this barrier layer 26 serves as a permeation barrier layer and the metal plates 24 are potentially already sufficiently sealed against permeation as a result of their material, for example because the material is aluminum sheet.

The adhesive strip 25 serves for fixing the position of the metal plates 24 during production, but also in the vacuum panel 21 as manufactured. The adhesive strip 25, therefore, does not itself have to be gas-tight.

It is, however, expedient to provide the adhesive strip 25 from a material by means of which the adhesive strip 25 acts as a permeation barrier, whose function is explained in further detail below, so that in cooperation with the material of the metal plates 24, depending on the conditions a barrier layer 26 is not (or no longer) required. Also in this case, various options may be conceived for evacuating the interior of the sleeve, as already explained with reference to FIGS. 7 to 9.

In FIG. 13 and FIG. 14, exemplary embodiments are shown which are able to dispense with plastic edging. This is possible if the losses through thermal conduction may be regarded as slight.

FIG. 13 shows a vacuum panel 31 with a sleeve which may be evacuated and/or is evacuated, which is described in further detail below, and with a filling 32 made of support elements, namely of granular or powdered degassed support elements, such as in particular silica particles. The sleeve consists substantially of two metal plates 34 and 35, which are connected in a fixed and gas-tight manner to one another peripherally by a weld seam 37. In the exemplary embodiment according to FIG. 13, one of the metal plates, the metal plate 35, is provided with a peripheral rim 38 bent back substantially at right angles, which in turn has an outwardly bent-back portion 39. This bent-back portion 39 is extremely close to a rim region 40 of the other metal plate 34, which in this case is configured as generally flat. At the outer ends, the weld seam 37 connecting the two metal plates 34 and 35 is provided. For the purposes of assembly, it may be exceptionally expedient to provide an adhesive layer 41 between the rim region 40 of the metal plate 34 and the border 39 of the metal plate 35.

Schematically shown by a dashed line is in turn the possibility for providing a barrier layer 36. The manner of evacuating the interior of the sleeve and/or the construction of the barrier layer 36 has already been described above.

FIG. 14 shows that an embodiment is also possible in which two metal plates of dish-shaped configuration may be used. FIG. 14 shows a vacuum panel 41 with a sleeve which may be evacuated and/or is evacuated and with a filling 42 made of support elements, namely of granular and/or powdered degassed support elements, such as in particular silica particles. The sleeve in this case consists of two metal plates 44 and 45 of substantially similar configuration, namely of dish-shaped configuration, with respective rims 48 and/or 49 bent over substantially at right angles, which at the edge portions facing one another via a peripheral gas-tight weld seam 47 are fixedly connected to one another, so that a sleeve is produced which is gas-tight and/or vacuum-tight overall. Also in this case, as shown schematically, a relatively thin barrier layer 46 may be provided.

The method of how the evacuation may be achieved and/or in which manner the barrier layer 46 may be configured has already been explained in detail above.

According to FIG. 15 a vacuum panel 51 has a sleeve which may be evacuated and/or is evacuated, which is described in further detail below, with a filling 52 made of support elements, namely of granular or powdered degassed support elements, such as in particular silica particles. The sleeve consists of a peripheral plastic edging 53 extending in the thickness direction, which is sealed at the ends by metal plates 54. The metal plates 54 have peripheral, substantially rounded rims 58, these rims 58 of the two metal plates 54 being spaced apart from one another. These rounded portions 58 may also be produced by a slight flanging. These peripheral rims 58 of the metal plates 54 are fixedly connected to one another by a peripheral adhesive strip 55, the adhesive strip 55 comprising rim regions 59 placed around the rims 58, which are bonded in position in the region of the metal plates 54. Expediently, each metal plate 54 in this region may have a peripheral bent-back portion 57 in which the rim region 59 of the adhesive strip 55 is bonded.

This arrangement is entirely enclosed peripherally by the plastic edging 53 so that the interior, i.e. the region between the metal plates 54 and the adhesive strip 55 is sealed in a gas-tight manner. Expediently, in this case, the peripheral bent-back portion 57 and the thickness of the plastic edging 53 is dimensioned in this region so that the outside of the plastic edging 53 lies substantially in one plane with the outside of the metal plate 54. The material of the filling 55 is introduced into the sleeve thus defined in a close-fitting manner. The interior of the sleeve is, in addition, evacuated. Moreover, in the exemplary embodiment shown, the sleeve has a relatively thin barrier layer 56 entirely enclosing the sleeve, shown schematically and only partially by dotted lines. As already explained in further detail above, this barrier layer on the metal plates 54 may be omitted, as this barrier layer 56 serves as a permeation barrier layer and the metal plates 54 are potentially already sufficiently sealed against permeation as a result of their material, for example because the material is aluminum sheet.

As already explained in the exemplary embodiment according to FIG. 12, the adhesive strip 55 serves for fixing the position and, therefore, does not itself have to be gas-tight but is expediently made of a material which may act as a permeation barrier. The interior of the sleeve may, as already explained with reference to FIGS. 7 to 9, also be evacuated and/or is evacuated.

1. A method of producing a substantially parallelepiped vacuum panel which has, in an outwardly gas-tight manner in a sleeve or envelope, a filling made of granular or powdered degassed support elements, the interior of the sleeve or envelope being evacuated and the support elements being compacted and enclosed by the sleeve or envelope, the sleeve or envelope including an encapsulation by injection-molding or overmolding of a plastic material,
the method comprising, for forming two sides of the sleeve or envelope remote from one another, arranging one metal plate on each side of the sleeve or envelope, between which the support elements are arranged, said metal plates having peripheral rims that are positively or formfit and non-positively or frictionally connected and embedded by the encapsulation by injection-molding and/or overmolding.

2. A method according to claim 1, comprising, for forming two sides of the sleeve remote from one another one metal plate is arranged on each side, between which the support elements are arranged, the peripheral rims of the two metal plates being spaced apart, the rims being bonded and connected to one another on the outside by a connecting adhesive strip and the rims and the adhesive strip (25) being positively encased by the encapsulation by injection-molding and/or overmolding of the plastic material.

3. A method according to claim 2, wherein the rims facing one another are bent back substantially at right angles.

4. A method according to claim 2, wherein the edge portions of the rims are substantially rounded.

5. A method according to claims 1, wherein the evacuation takes place through an opening in one of the plates, which after the evacuation is sealed in a gas-tight manner by a closure.

6. A method according to claims 1, wherein the evacuation takes place through an opening in the encapsulation by injection-molding and/or overmolding, which is sealed in a gas-tight manner after evacuation by bonding a plastic plug in position.

7. A method according to claims 1, wherein the arrangement of plates and support elements is introduced into a mold, the mold is evacuated and the encapsulation by injection-molding and/or overmolding takes place in the evacuated mold.

8. A method according to claim 1, wherein the peripheral rims comprise a flanged portion which face one another in the two plates.

9. A method according to claim 1, wherein the peripheral rims have a peripheral perforation through which the encapsulation by injection-molding and/or overmolding takes place.

10. A method according to claim 2, wherein the adhesive strip comprises a material or is equipped so that it has a permeation barrier effect.

11. A method according to claim 10, wherein the adhesive strip is guided around the rims into the region of the plane of the metal plates.

12. A method according to claim 11, wherein the metal plate in the region receiving a bent-back rim region of the adhesive strip comprises a peripheral bent-back portion, wherein after the encapsulation by injection-molding and/or overmolding of the plastic material, the outer faces of the plastic material are located in the plane of the central region of the respective metal plate.

13. A method according to claim 1, wherein a permeation barrier layer made of a material of low thermal conductivity and low permeation capacity is subsequently applied at least on the encapsulation by injection-molding and/or overmolding.

14. A method of producing a substantially parallelepiped vacuum panel which has, in an outwardly gas-tight manner in a sleeve or envelope, a filling made of granular or powdered degassed support elements, the interior of the sleeve or envelope being evacuated and the support elements being moved closely together and being enclosed by the sleeve or envelope,
the method comprising, for forming two sides of the sleeve remote from one another one metal plate is arranged, between which the support elements are arranged on each side, at least one of the metal plates comprising a rim bent over substantially at right angles, which is arranged facing the other metal plate and almost touching it in the rim region, wherein the two metal plates are fixedly connected by a peripheral gas-tight weld seam.

15. A method according to claim 14, wherein the bent-over rim is again outwardly bent back peripherally, this bent-back portion being connected to the rim region of the other metal plate by a bonding layer, and then the weld seam connecting the two metal plates is provided.

16. A method according to claim 14, wherein both metal plates comprise the bent-back rim and their edge portions are connected to one another by the weld seam.

17. A method according to claim 14, wherein the evacuation takes place through an opening in one of the plates, which after the evacuation is sealed in a gas-tight manner by a closure.

18. A method according to claim 14, wherein the arrangement of plates and support elements is inserted into a mold, the mold is evacuated, and the weld seam is provided in the evacuated mold.

19. A method according to claim 14, wherein a permeation barrier layer made of a material of lower thermal conductivity and lower permeation capacity is subsequently applied.

20. A method according to claim 13, wherein an aluminum layer is applied.

21. A method according to claim 13, wherein a quartz-like layer is applied.

22. A method according to claim 1, wherein between the support elements getter materials are provided, which are activated after the evacuation.

23. A vacuum panel with a substantially parallelepiped shape comprising an outwardly gas-tight sleeve or envelope with a filling made of granular or powdered degassed support elements, the interior of the sleeve or envelope being evacuated so that the support elements are moved closely together and enclosed by the sleeve or envelope, the sleeve or envelope including an encapsulation by injection-molding or overmolding of a plastic material,
wherein for forming two sides of the sleeve remote from one another one metal plate is provided on each side, between which the support elements are arranged and whose peripheral rims are positively or formfit and non-positively or frictionally connected embedded by the encapsulation by injection-molding and/or overmolding with the plastic material.

24. A vacuum panel according to claim 23, wherein for forming two sides of the sleeve or envelope remote from one another one respective metal plate is provided, between which the support elements are arranged, the peripheral rims of both metal plates being spaced apart, the rims being bonded and connected to one another on the outside by a connecting adhesive strip and the rims and the adhesive strip being positively encased by the encapsulation by injection-molding and/or overmolding of the plastic material.

25. A vacuum panel according to claim 24, wherein the rims facing one another are bent back substantially at right angles.

26. A vacuum panel according to claim 24, wherein the peripheral rims are substantially simply rounded.

27. A vacuum panel according to claim 23, wherein at least one of the metal plates has at least one evacuation opening, which after the evacuation, is sealed in a gas-tight manner by a closure.

28. A vacuum panel according to claim 23, wherein for the encapsulation by injection-molding and/or overmolding at least one evacuation opening is provided, which after evacuation is sealed in a gas-tight manner by bonding a plastic plug in position.

29. A vacuum panel according to claim 23, wherein the peripheral rims comprise a flanged portion which face one another in the two plates.

30. A vacuum panel according to claim 23, wherein the peripheral rims have a peripheral perforation, through which the encapsulation by injection-molding and/or overmolding takes place.

31. A vacuum panel according to claim 24, wherein the adhesive strip comprises a material or is equipped so that it has a permeation barrier effect.

32. A vacuum panel according to claim 31, wherein the adhesive strip is guided around the rims into the region of the metal plates.

33. A vacuum panel according to claim 32, wherein the metal plate in the region receiving a bent-back rim region of the adhesive strip comprises a peripheral bent-back portion, wherein after the encapsulation by injection-molding and/or overmolding of the plastic material the outer faces of the plastic material are located in the plane of the central region of the respective metal plate.

34. A vacuum panel according to claim 23, wherein a permeation barrier layer made of a material of lower thermal conductivity is applied at least on the encapsulation by injection-molding and/or overmolding.

35. A vacuum panel with a substantially parallelepiped shape comprising an outwardly gas-tight sleeve or envelope with a filling made of granular or powdered degassed support elements, the interior of the sleeve or envelope being evacuated so that the support elements are moved closely together and enclosed by the sleeve or envelope,
wherein for forming two sides of the sleeve remote from one another one metal plate is arranged on each side, between which the support elements are arranged, at least one of the metal plates having a rim bent over substantially at right angles, which is arranged facing the other metal plate and almost touching it in the rim region, and in that the two metal plates are connected fixedly and in a gas-tight manner by a peripheral weld seam.

36. A vacuum panel according to claim 35, wherein the bent-over rim is in turn outwardly bent back peripherally, this bent-back portion being connected to the rim region of the other metal plate by an adhesive layer and then the weld seam connecting the two metal plates is provided.

37. A vacuum panel according to claim 35, wherein both metal plates have the bent-back rim and their edge portions are connected to one another in a gas-tight manner by the weld seam.

38. A vacuum panel according to claim 35, wherein at least one of the metal plates has at least one evacuation opening, which after the evacuation is sealed in a gas-tight manner by a closure.

39. A vacuum panel according to claim 35, wherein a permeation barrier layer made of a material of lower thermal conductivity is applied.

40. A vacuum panel according to claim 34, wherein the permeation barrier layer is formed by an aluminum layer, by vapor-deposition or sputtering.

41. A vacuum panel according to claim 34, wherein the permeation barrier layer is formed by a quartz-like layer.

42. A vacuum panel according to claim 23, wherein between the support elements getter materials are provided, which may be activated from outside the sleeve or envelope.

43. A thermally insulating, multi-shell masonry block, comprising an inner shell, an outer shell, and thermal insulation formed by a vacuum panel according to claim 23 between the inner shell and outer shell are connected to one another, the metal plates bearing against the surfaces of the inner shell and/or the outer shell facing one another.

44. A method according to claim 1, wherein the support elements comprise silica particles.

45. A method according to claim 10, wherein the adhesive strip has a permeation barrier effect in the same order of magnitude as that of the material of the metal plates.

46. A method according to claim 14, wherein the support elements comprise silica particles.

47. A method according to claim 20, wherein the aluminum layer is applied by vapor-deposition or sputtering.

48. A method according to claim 21, wherein the quartz-like layer is based on hexamethyl disilazane (HMDS).

49. A method according to claim 22, wherein between the getter materials are in pellet form and are activated after the evacuation after applying the permeation barrier layer.

50. A vacuum panel according to claim 31, wherein the adhesive strip has a permeation barrier effect in the same order of magnitude as that of the material of the metal plates.

51. A vacuum panel according to claim 35, wherein the support elements comprise silica particles.

52. A vacuum panel according to claim 41, wherein the quartz-like layer is based on hexamethyl disilazane (HMDS).

53. A vacuum according to claim 42, wherein between the getter materials are in pellet form.
